(19) United States
(12) Patent Application Publication
(10) Pub. No.: US 2008/0083234 A1
(43) Pub. Date: Apr. 10, 2008

(54) APPARATUS AND METHOD FOR LOGGING DATA FROM A HEATING, VENTILATION, AND AIR CONDITIONING SYSTEM

(76) Inventors: Steve Krebs, Las Vegas, NV (US); Ronald L. Pitt, Cardiff by the Sea, CA (US); Robert Zirpoli, Henderson, NY (US)

Correspondence Address: Thomas & Raring, P.C., 536 GRANITE AVENUE, RICHMOND, VA, 23226, US

(21) Appl. No.: 11/538,587

(22) Filed: Oct. 4, 2006

(51) Int. Cl. G01K 13/00

(52) U.S. Cl. 62/129

(57) ABSTRACT

A method for logging data from an HVAC system comprises the steps of: collecting, within a thermostat, a plurality of data elements corresponding to a current time, at least one user setting, at least one HVAC system state, and at least one environmental measurement; correlating, within the thermostat, the collected data elements according to the current time; and storing, within the thermostat, the collected data elements. The method may further comprise the steps of: transmitting the stored data elements from the thermostat to an external device; and analyzing, within the external device, the transmitted data to determine energy savings. The data may be transmitted from the thermostat when the thermostat receives a request from the external device. The data may be transmitted from the thermostat to the external device over a communication link comprising one of a hard-wired communication link or a radio frequency communication link.

### FIELD OF THE INVENTION

This invention relates to the temperature and other climate control of interiors of buildings, and in particular to systems and methods for logging data from such climate control systems.

### BACKGROUND OF THE INVENTION

In conventional temperature or climate control systems (e.g. heating, ventilating and air conditioning systems, referred to herein generally as “HVAC systems”), thermostats are used to control when the HVAC system turns on and off. The user presets a desired temperature (or “user setpoint”), and when the temperature of the controlled space is different from the preset temperature, the HVAC system heats or cools the air until the preset temperature is reached. Due to the high cost of energy, many HVAC systems and thermostats include features designed to improve energy efficiency and thus reduce heating and cooling costs. For example, some thermostats feature variable setpoint temperatures, such that the setpoint temperature may vary over time. Such a variable setpoint temperature may be programmed to change the setpoint temperature (e.g., increase the cooling setpoint temperature or decrease the heating setpoint temperature) during times when the occupants of the climate-controlled space are expected to be absent. HVAC systems and thermostats with energy saving features are especially important in large facilities, such as hotels, where minor improvements in energy efficiency can result in large cost savings.

Many variables can affect the energy usage within a particular facility, and there are many ways in which these variables can be adjusted to attempt to decrease energy usage. It is important to be able to measure and analyze energy usage corresponding to these variable adjustments to determine which variable adjustments decrease energy usage (and therefore are desirable to duplicate) and which variable adjustments increase or have no effect on energy usage (and therefore are not desirable to duplicate). Conventional HVAC systems and thermostats record may record setpoint temperatures and current temperatures within a climate-controlled space. However, the recording of only such limited data makes it difficult to comprehensively analyze energy usage to identify and track energy saving strategies.

### BRIEF SUMMARY OF THE INVENTION

The object of the present invention is to overcome the aforementioned drawbacks and to provide a method and apparatus for logging data from an HVAC system to enable comprehensive analysis of energy usage and savings to increase energy efficiency and decrease energy costs.

In one embodiment of the invention, a method for logging data from an HVAC system comprises the steps of: collecting, within a thermostat, a plurality of data elements corresponding to a current time, at least one user setting, at least one HVAC system state, and at least one environmental measurement; correlating, within the thermostat, the collected data elements according to the current time; and storing, within the thermostat, the collected data elements. The method may further comprise the steps of: transmitting the stored data elements from the thermostat to an external device; and analyzing, within the external device, the transmitted data to determine energy savings. The data may be transmitted from the thermostat when the thermostat receives a request from the external device. The data may be transmitted from the thermostat to the external device over a communication link comprising one of a hard-wired communication link or a radio frequency communication link.

The at least one user setting may comprise at least one of an HVAC system setting, a fan setting, or a setpoint temperature. The at least one HVAC system state may comprise at least one of an operating level, a fan state, an emergency heat state, a ventilation source state, or a humidity control state. The at least one environmental measurement may comprise at least one of an occupancy status or a light level.

In another embodiment of the invention, an apparatus for governing a temperature of a room by controlling an operation of an HVAC comprises an interface, a controller, and a temperature sensor. The interface is coupled to the HVAC system to control the operation thereof by control signals. The controller includes a processor coupled to a memory. The memory stores an environmental control program including program instructions for controlling the operation of the HVAC system by generating the control signals and further storing data. The temperature sensor is coupled to the controller and provides, at any given time, a signal representing the temperature within the room. The controller is configured to collect a plurality of data elements corresponding to a current time, at least one user setting, at least one HVAC system state, and at least one environmental measurement. The controller is further configured to correlate the collected data elements according to the current time. The controller is further configured to store the collected data elements.

The controller may be further configured to transmit the stored data elements from the thermostat to an external device capable of analyzing the transmitted data to determine energy savings. The controller may transmit the data when the controller receives a request from the external device. The controller may transmit the data to the external device over a communication link comprising one of a hard-wired communication link or a radio frequency communication link.

The at least one user setting may comprise at least one of an HVAC system setting, a fan setting, or a setpoint temperature. The at least one HVAC system state may comprise at least one of an operating level, a fan state, an emergency heat state, a ventilation source state, or a humidity control state. The at least one environmental measurement may comprise at least one of an occupancy status or a light level.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram illustrating a data logging thermostat, in accordance with an embodiment of the invention; and

FIG. 2 is a flow chart illustrating a method of logging data from an HVAC system, in accordance with an embodiment of the invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

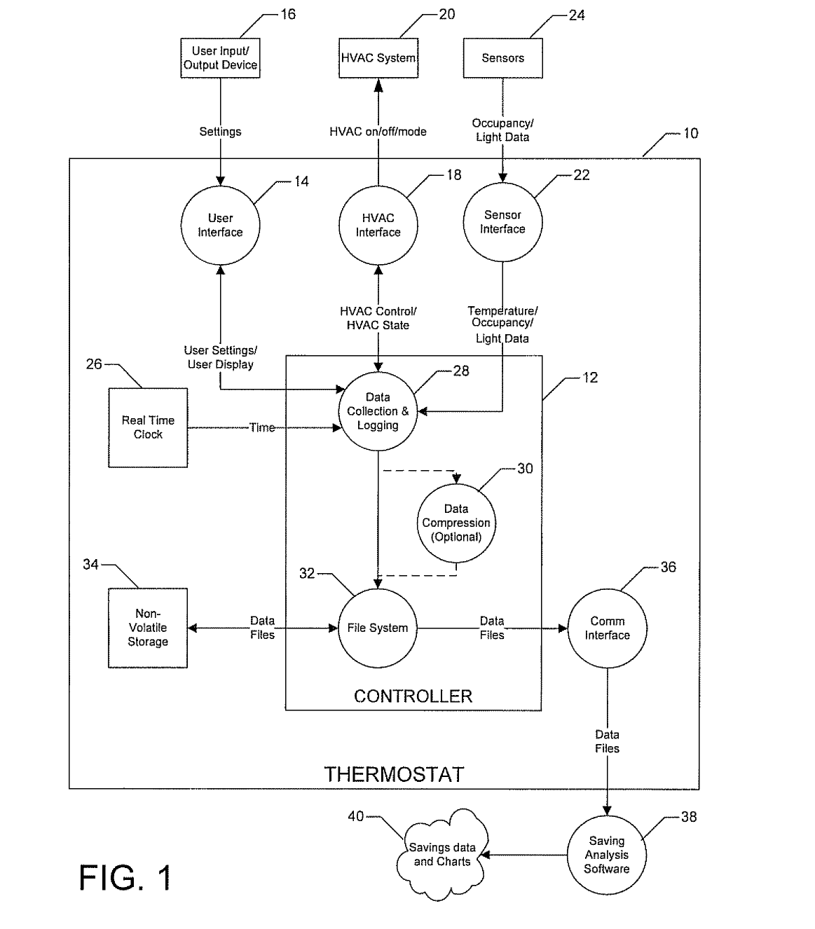

The present invention is directed to an apparatus and method for logging data from an HVAC system to enable comprehensive analysis of energy usage and savings to increase energy efficiency and decrease energy costs. The invention may be implemented in a thermostat 10, as illustrated in FIG. 1, capable of controlling levels of a predetermined environmental attribute (e.g., temperature or humidity) of a room or enclosed space by operating an environmental control unit or equipment (e.g., an HVAC system) in response to changes in such attribute levels, so as to keep the current level of the attribute in the room within a certain range of a user setpoint, i.e. a user-determined desired level for the attribute. The thermostat 10 may function in a conventional manner to control an HVAC system. The thermostat may comprise a controller 12 for receiving user settings (e.g., setpoint temperature) from a user input/output device 16 via a user interface 14. The user input/output device 16 may include a keyboard, microphone for voice control, infrared or radio remote devices, touch screens, or any one of many other conventional input devices for thermostats, including input ports for communications from computers or electronic devices, as well as a display screen and/or indicator lights to provide information to the user. One or more environmental attribute sensors 24 (e.g., temperature, humidity, light, and occupancy sensors) may be coupled to the thermostat such that the controller receives data from these sensors via a sensor interface 22. The sensors may be coupled to the thermostat via a conventional remote means, such as infrared, radio frequency, or building wiring. The controller may also receive current time data from a real time clock 26. The controller may also access a preprogrammed climate control algorithm stored in a memory device, such as non-volatile storage device 34. Using the received user settings and sensor data, and based on the preprogrammed climate control algorithm, the controller 12 may control an HVAC system 20 by sending control signals via an HVAC interface. These control signals cause the HVAC system to turn on and off and to enter the desired mode (e.g., heating or cooling).

While the controller 12 may be configured in various manners, the controller may be comprised of a microprocessor, dedicated electronic circuitry (e.g., an application specific integrated circuit), general purpose electronic circuitry (e.g., a field programmable gate array), a suitably programmed computing device, or any other suitable means of controlling a thermostat.

As described in further detail below, the controller may log, correlate, and output data to enable a comprehensive analysis of energy usage and savings. Thus the controller may have a data collection/logging element 28 that periodically receives data from various data sources, both internal and external to the thermostat. For example, the data collection/logging element 28 may receive data from the real time clock, from the user interface, from the HVAC interface, and from the sensor interface. The data collection/logging element may receive the current time from the clock. The data collection/logging element may receive user setting values from the user interface. The user setting values may include an HVAC system setting (e.g., off, heat only, cool only, or auto), a fan setting (e.g, auto, low, medium or high), or a setpoint temperature. The data collection/logging element may receive HVAC system state values from the HVAC interface. These values represent the HVAC features and functions that the thermostat currently has engaged. The HVAC system state values may include an operating level (e.g., off, cool low, cool medium, cool high, heat low, heat medium, or heat high), a fan state (e.g., off, low, medium, or high), an emergency heat state (e.g., off or on), a ventilation source state (e.g., inside or outside), or a humidity control state (e.g., off or on). The data collection/logging element may receive an environmental measurement from the sensor interface. The environmental measurement may include a current temperature, an occupancy status, or a light level. It should be appreciated that the data elements described herein as being received by the data collection/logging element are for illustration purposes only. Embodiments of the invention may collect all of these data elements, a subset of these data elements, and/or other data elements not described herein.

After the data collection/logging element receives data from one or more data sources, the data is correlated according to the time the data is collected. The correlated data may then be sent to a file system element 32 that stores the data in storage element 34. Optionally, the data may be compressed by data compression element 30 before being stored, to enable greater data storage capacity. The file system element 32 may also transmit the data, via a communication interface 36, to a computing device 38 capable of analyzing energy usage and savings and producing usage/savings data and charts 40.

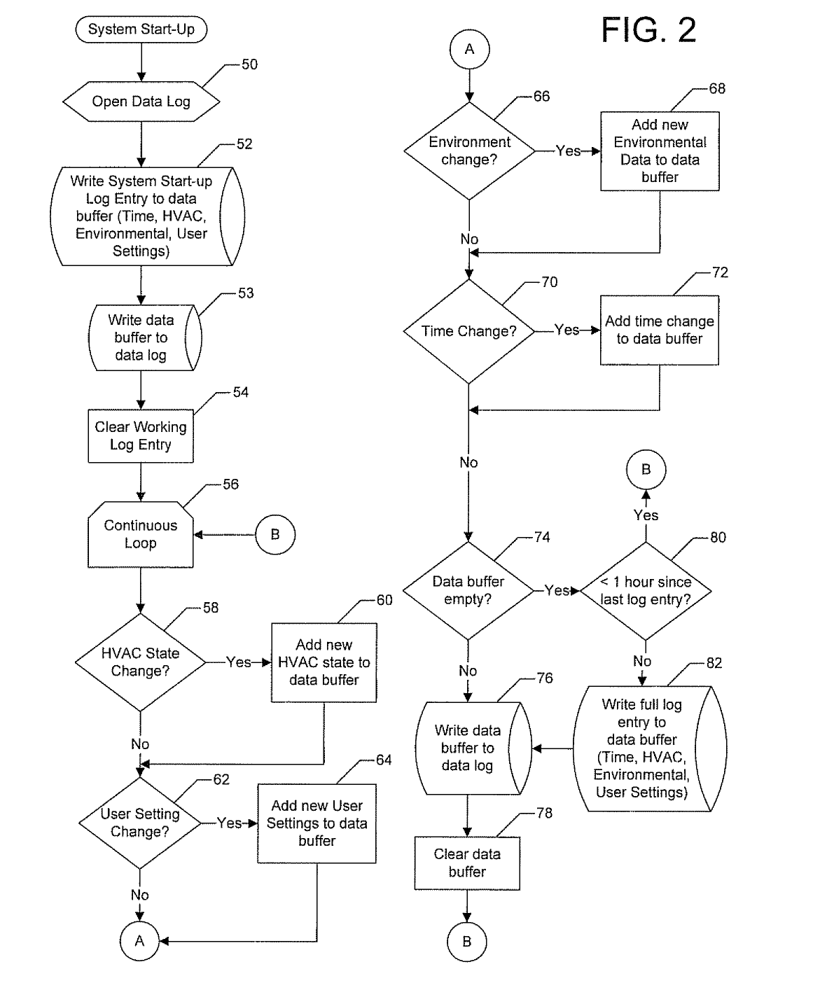

Referring now to FIG. 2, a method of logging data from an HVAC system is illustrated, in accordance with an embodiment of the invention. The method of the present invention will typically store logged data in a temporary data buffer (the temporary file may be termed a “working log”) in a temporary memory element (such as random access memory) (not illustrated in FIG. 1), before writing the data into a data file in the non-volatile memory (the data file in the non-volatile memory may be termed a “data log”). Upon start-up of the thermostat, a data log is opened (see box 50) into which the collected data may be written. An existing data log may be opened such that the newly collected data is concatenated to data already in the data log. Alternatively, a new (i.e., empty) data log may be created and opened. An initial, complete set of data (time, HVAC settings, user settings, and environmental data) is collected, correlated to the time the data was collected, and written into the data buffer (see box 52).). In addition to a complete set of data, this system start-up log entry typically includes information to indicate that the data was collected at system start-up. The data is then written from the data buffer into the data log (see box 53). Although not illustrated, the data may be compressed prior to writing the data into the data log. The data buffer is then cleared of data (see box 54).

A sequence of actions (illustrated in boxes 56 through 78) may then be repeatedly performed in which any changes to collected data are detected such that the changed data may be written to the data buffer and then to the data log. This sequence of actions may be performed repeatedly on a periodic basis, typically until the thermostat is shut off. The frequency at which this sequence is repeated may vary, depending upon the amount of data desired and the amount of memory available in which to store the data. For example, in a thermostat with a relatively small data storage capacity, this sequence may be repeated every fifteen, thirty, or even sixty minutes. In contrast, in a thermostat with a relatively large data storage capacity, this sequence may be repeated every minute or even every second. In boxes 58 and 60, it is determined whether an HVAC state change occurred (e.g., a change from cool low to cool medium), and if so the new HVAC state is entered in the data buffer. In boxes 62 and 64, it is determined whether a user setting change occurred (e.g., a change to the setpoint temperature), and if so the new user setting is entered in the data buffer. In boxes 66 and 68, it is determined whether a change to any of the environmental data occurred (e.g., the occupancy status changes from unoccupied to occupied), and if so the new environmental data is entered in the data buffer. In boxes 70 and 72, it is determined whether a change to the system time occurred (i.e., whether a user changed the clock setting), and if so the time is entered in the data buffer.

It may then be determined if the data buffer is empty (i.e., did any data changes occur which were recorded in the data buffer?) (see box 74). If there is data in the data buffer, the data is correlated to the time the data was collected and written into the data log (see box 76), along with the time the data was collected. The data buffer is then cleared of data (see box 78). Even when no data changes are occurring, it still may be desirable to record a complete set of data on a periodic basis, such as once per hour. Thus, if it is determined in box 74 that the data buffer is empty (i.e., that no data changes occurred, and thus no data changes were recorded, during the immediately preceding sequence of the execution of boxes 58 through 72), it is determined how much time has elapsed since the last entry of data into the data log. If the elapsed time is equal to or greater than one hour (see box 80), a complete set of data (time, HVAC settings, user settings, and environmental data) is collected and correlated to the time the data was collected, and written into the data buffer (see box 82). The complete set of data in the data buffer is then written to the data log (see box 76) and the data buffer is cleared (see box 78). If the elapsed time is less than one hour (see box 80), the sequence of actions illustrated in boxes 56 through 78 is again performed.

The collected data is typically stored in the thermostat as data log files in a file system that resides in non-volatile storage (e.g., flash memory). These files may be named using the following convention: RunTime_LOCATION_SEQUENCE#.rtlog. For example the file “RunTime_HILTON Las Vegas Room 101_{—}00001.rtlog is the first log file created in the thermostat in room 101 of the Hilton Las Vegas. The collected data may be transmitted to an external device, such as a central HVAC system computer, for analysis. The data may be sent from the thermostat to the external device by simply downloading these files from the thermostat using a known communications means, such as an RS-232 port on the thermostat or an RF communications link built into the thermostat. The collected data may be transmitted from the thermostat upon receiving a request from the external device, or the data may be transmitted automatically on a predetermined schedule. When the thermostat is to transmit the data, either in response to a request or on an automatic schedule, the thermostat typically closes the file, sends the file to the external device, and creates a new file named with the next sequence number. The thermostat may either maintain the transmitted file in the thermostat memory for a predetermined period of time or as storage space allows, or the thermostat may delete the file after transmitting the file to the external device. Once the file is transmitted to the external device, the new data can be concatenated to any data for that room which had been downloaded earlier, such that a large amount of data spanning a long period of time may be analyzed.

As discussed above, the energy usage information may be used to gauge the success of energy savings strategies. The information may also be used for diagnostic purposes. When recent data is compared to historical data, it may be possible to identify changes in energy usage patterns that are indicative of equipment or other problems. For example, a failing compressor in an air conditioning unit may cause a significant and unexpected increase in energy usage that can be investigated by appropriate maintenance personnel. Similarly, a window inadvertently left open by a hotel room occupant may noticeably affect the heating or cooling of that room, thereby alerting hotel staff of a potential problem that should be investigated.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for logging data from a heating, ventilation, and air conditioning (HVAC) system, the method comprising:
collecting, within a thermostat, a plurality of data elements corresponding to a current time, at least one user setting, at least one HVAC system state, and at least one environmental measurement;
correlating, within the thermostat, the collected data elements according to the current time; and
storing, within the thermostat, the collected data elements.

2. The method of claim 1, further comprising:
transmitting the stored data elements from the thermostat to an external device; and
analyzing, within the external device, the transmitted data to determine energy savings.

3. The method of claim 2, wherein the data is transmitted from the thermostat when the thermostat receives a request from the external device.

4. The method of claim 2, wherein the data is transmitted from the thermostat to the external device over a communication link comprising one of a hard-wired communication link or a radio frequency communication link.

5. The method of claim 1, wherein the at least one user setting comprises at least one of an HVAC system setting, a fan setting, or a setpoint temperature.

6. The method of claim 1, wherein the at least one HVAC system state comprises at least one of an operating level, a fan state, an emergency heat state, a ventilation source state, or a humidity control state.

7. The method of claim 1, wherein the at least one environmental measurement comprises at least one of an occupancy status or a light level.

8. An apparatus for governing a temperature of a room by controlling an operation of a heating, ventilation, and air conditioning (HVAC) system, the apparatus comprising:
an interface coupled to the HVAC system to control the operation thereof by control signals;
a controller including a processor coupled to a memory, the memory storing an environmental control program including program instructions for controlling the operation of the HVAC system by generating the control signals and further storing data; and
a temperature sensor coupled to the controller for providing, at any given time, a signal representing the temperature within the room;
wherein the controller is configured to collect a plurality of data elements corresponding to a current time, at least one user setting, at least one HVAC system state, and at least one environmental measurement; wherein the controller is further configured to correlate the collected data elements according to the current time; and wherein the controller is further configured to store the collected data elements.

9. The apparatus of claim 8, wherein the controller is further configured to transmit the stored data elements from the thermostat to an external device capable of analyzing the transmitted data to determine energy savings.

10. The apparatus of claim 9, wherein the controller transmits the data when the controller receives a request from the external device.

11. The apparatus of claim 9, wherein the controller transmits the data to the external device over a communication link comprising one of a hard-wired communication link or a radio frequency communication link.

12. The apparatus of claim 8, wherein the at least one user setting comprises at least one of an HVAC system setting, a fan setting, or a setpoint temperature.

13. The apparatus of claim 8, wherein the at least one HVAC system state comprises at least one of an operating level, a fan state, an emergency heat state, a ventilation source state, or a humidity control state.

14. The apparatus of claim 8, wherein the at least one environmental measurement comprises at least one of an occupancy status or a light level.
